(19) United States
(12) Patent Application Publication
(10) Pub. No.: US 2024/0326189 A1
(43) Pub. Date: Oct. 3, 2024

(54) POWER TOOL AND POWER-OFF PROTECTION METHOD THEREOF

(71) Applicant: Nanjing Chervon Industry Co., Ltd., Nanjing (CN)

(72) Inventors: Yinghao Zhang, Nanjing (CN); Shutao Zheng, Nanjing (CN)

(21) Appl. No.: 18/432,765

(22) Filed: Feb. 5, 2024

(30) Foreign Application Priority Data
Mar. 29, 2023 (CN) 202310323539.X

(51) Int. Cl. B23Q 11/00

(52) U.S. Cl. CPC B23Q 11/0085

(57) ABSTRACT

A power tool includes a motor, a power terminal, a detection module, and a controller. The power terminal is configured to access a power supply of a battery pack. The detection module is capable of detecting that a first circuit between the power terminal and the battery pack is in a power-on mode or a power-off mode. The controller is capable of controlling a second circuit between the power terminal and the motor to be in a power-on mode or a power-off mode. When the detection module detects that the first circuit is switched from the power-on mode to the power-off mode, the controller controls the second circuit to be in the power-off mode within a first preset time.

### RELATED APPLICATION INFORMATION

This application claims the benefit under 35 U.S.C. § 119(a) of Chinese Patent Application No. 202310323539.X, filed on Mar. 29, 2023, which application is incorporated herein by reference in its entirety.

### TECHNICAL FIELD

The present application relates to the field of electronic technologies and, in particular, to a power tool and a power-off protection method thereof.

### BACKGROUND

Power tools such as a miter saw or an angle grinder have relatively high inertia. Therefore, the motor of this type of power tool coasts for a relatively long time after power-off. If a user turns on a switch and the power tool is powered again during the coast time of the motor after the power-off, the power tool may be caused to run again, thus causing a great security risk to an unprepared person near the power tool.

This part provides background information related to the present application, which is not necessarily the existing art.

### SUMMARY

A power tool includes a motor, a power terminal, a detection module, and a controller. The power terminal is configured to access a power supply of a battery pack. The detection module is capable of detecting that a first circuit between the power terminal and the battery pack is in a power-on mode or a power-off mode. The controller is capable of controlling a second circuit between the power terminal and the motor to be in a power-on mode or a power-off mode. The controller is configured to, when the detection module detects that the first circuit is switched from the power-on mode to the power-off mode, control the second circuit to be in the power-off mode within a first preset time.

In some examples, the controller is configured to, when the detection module detects, within the first preset time, that the first circuit is in the power-on mode again, control the second circuit to be in the power-off mode within the first preset time.

In some examples, the controller is configured to, when the detection module detects, outside the first preset time, that the first circuit is in the power-on mode, control the second circuit to be in the power-on mode.

In some examples, the power tool further includes an operation switch capable of controlling the second circuit to be in the power-on mode or the power-off mode, where the controller controls the second circuit to be in the power-off mode when the operation switch is in the off state.

In some examples, the power tool further includes an operation switch capable of controlling the second circuit to be in the power-on mode or the power-off mode, where the second circuit is in the power-off mode when the operation switch is in the off state, and the controller controls the second circuit to be in the power-on mode or the power-off mode when the operation switch is in the on state.

In some examples, the controller is configured to, when the operation switch is in the on state within the first preset time and the detection module detects, within the first preset time, that the first circuit is in the power-on mode again, control the second circuit to be in the power-off mode within the first preset time.

In some examples, the controller is configured to, when the operation switch is in the on state outside the first preset time and the detection module detects, outside the first preset time, that the first circuit is in the power-on mode, control the second circuit to be in the power-on mode.

In some examples, the controller is configured to, when the operation switch is switched from the off state to the on state within the first preset time and the detection module detects, within the first preset time, that the first circuit is in the power-on mode again, control the second circuit to be in the power-off mode within the first preset time.

In some examples, the power tool further includes a communication terminal configured to perform data communication with the battery pack, where the detection module is capable of detecting whether a level of the communication terminal varies.

In some examples, the detection module determines, based on whether the level of the communication terminal varies, that the first circuit is in the power-on mode or the power-off mode.

In some examples, the detection module is also capable of detecting a phase current of the motor and determining, based on the magnitude of the phase current of the motor, that the first circuit is in the power-on mode or the power-off mode.

In some examples, the detection module is also capable of detecting a phase current of the motor. The detection module is configured to, when the absolute value of the phase current of the motor is less than a preset current threshold and the level of the communication terminal does not vary within a second preset time, determine that the first circuit is in the power-off mode.

In some examples, the detection module is also capable of detecting a back electromotive force of the motor and a bus voltage of the motor. The detection module is configured to, when the difference between the back electromotive force of the motor and the bus voltage of the motor is less than a preset voltage threshold within a third preset time, determine that the first circuit is in the power-off mode.

In some examples, the battery pack is plugged into the power tool, where the first circuit is in the power-on mode when the battery pack is plugged into the power tool, and the first circuit is in the power-off mode when the battery pack is pulled out of the power tool.

In some examples, the first preset time is greater than or equal to a coast time of the motor.

A power tool includes: a motor; a power terminal configured to access a power supply of a battery pack; a detection module capable of detecting that a first circuit between the power terminal and the battery pack is in a power-on mode or a power-off mode; and a controller capable of controlling a second circuit between the power terminal and the motor to be in a power-on mode or a power-off mode. The controller is configured to, when the detection module detects that the first circuit is switched from the power-off mode to the power-on mode, control the second circuit to be in the power-off mode if a time when the first circuit is in the power-off mode before the switchover does not exceed a first preset time.

In some examples, the first preset time is greater than or equal to 2 seconds and less than or equal to 10 seconds.

In some examples, the controller is configured to, when the detection module detects that the first circuit is switched from the power-off mode to the power-on mode, control the second circuit to be in the power-on mode if a time when the first circuit is in the power-off mode before the switchover exceeds the first preset time.

In some examples, the power tool further includes an operation switch, where

the controller is configured to, when the detection module detects that the first circuit is switched from the power-off mode to the power-on mode, control the second circuit to be in the power-off mode if the operation switch is in the on state and a time when the first circuit is in the power-off mode before the switchover does not exceed the first preset time.

A power-off protection method of a power tool is provided, where the power tool includes a motor, a power terminal, a detection module, and a controller. The power terminal is configured to access a power supply of a battery pack. The detection module is capable of detecting that a first circuit between the power terminal and the battery pack is in a power-on mode or a power-off mode. The controller is capable of controlling a second circuit between the power terminal and the motor to be in a power-on mode or a power-off mode. The power-off protection method includes the step: when the detection module detects that the first circuit is switched from the power-on mode to the power-off mode, the controller controls the second circuit to be in the power-off mode within a first preset time.

### BRIEF DESCRIPTION OF THE DRAWINGS

FIG. 1 is a perspective view of a power tool according to an example of the present application;

FIG. 2 is a block diagram of a power-off protection circuit of a power tool according to an example of the present application; and

FIG. 3 is a flowchart of a power-off protection method of a power tool according to an example of the present application.

### DETAILED DESCRIPTION

Before any examples of this application are explained in detail, it is to be understood that this application is not limited to its application to the structural details and the arrangement of components set forth in the following description or illustrated in the above drawings.

In this application, the terms “comprising”, “including”, “having” or any other variation thereof are intended to cover an inclusive inclusion such that a process, method, article or device comprising a series of elements includes not only those series of elements, but also other elements not expressly listed, or elements inherent in the process, method, article, or device. Without further limitations, an element defined by the phrase “comprising a . . . ” does not preclude the presence of additional identical elements in the process, method, article, or device comprising that element.

In this application, the term “and/or” is a kind of association relationship describing the relationship between associated objects, which means that there can be three kinds of relationships. For example, A and/or B can indicate that A exists alone, A and B exist simultaneously, and B exists alone. In addition, the character “/” in this application generally indicates that the contextual associated objects belong to an “and/or” relationship.

In this application, the terms “connection”, “combination”, “coupling” and “installation” may be direct connection, combination, coupling or installation, and may also be indirect connection, combination, coupling or installation. Among them, for example, direct connection means that two members or assemblies are connected together without intermediaries, and indirect connection means that two members or assemblies are respectively connected with at least one intermediate members and the two members or assemblies are connected by the at least one intermediate members. In addition, “connection” and “coupling” are not limited to physical or mechanical connections or couplings, and may include electrical connections or couplings.

In this application, it is to be understood by those skilled in the art that a relative term (such as “about”, “approximately”, and “substantially”) used in conjunction with quantity or condition includes a stated value and has a meaning dictated by the context. For example, the relative term includes at least a degree of error associated with the measurement of a particular value, a tolerance caused by manufacturing, assembly, and use associated with the particular value, and the like. Such relative term should also be considered as disclosing the range defined by the absolute values of the two endpoints. The relative term may refer to plus or minus of a certain percentage (such as 1%, 5%, 10%, or more) of an indicated value. A value that did not use the relative term should also be disclosed as a particular value with a tolerance. In addition, “substantially” when expressing a relative angular position relationship (for example, substantially parallel, substantially perpendicular), may refer to adding or subtracting a certain degree (such as 1 degree, 5 degrees, 10 degrees or more) to the indicated angle.

In this application, those skilled in the art will understand that a function performed by an assembly may be performed by one assembly, multiple assemblies, one member, or multiple members. Likewise, a function performed by a member may be performed by one member, an assembly, or a combination of members.

In this application, the terms “up”, “down”, “left”, “right”, “front”, and “rear” and other directional words are described based on the orientation or positional relationship shown in the drawings, and should not be understood as limitations to the examples of this application. In addition, in this context, it also needs to be understood that when it is mentioned that an element is connected “above” or “under” another element, it can not only be directly connected “above” or “under” the other element, but can also be indirectly connected “above” or “under” the other element through an intermediate element. It should also be understood that orientation words such as upper side, lower side, left side, right side, front side, and rear side do not only represent perfect orientations, but can also be understood as lateral orientations. For example, lower side may include directly below, bottom left, bottom right, front bottom, and rear bottom.

In this application, the terms “controller”, “processor”, “central processor”, “CPU” and “MCU” are interchangeable. Where a unit “controller”, “processor”, “central processing”, “CPU”, or “MCU” is used to perform a specific function, the specific function may be implemented by a single aforementioned unit or a plurality of the aforementioned unit.

In this application, the term “device”, “module” or “unit” may be implemented in the form of hardware or software to achieve specific functions.

In this application, the terms “computing”, “judging”, “controlling”, “determining”, “recognizing” and the like refer to the operations and processes of a computer system or similar electronic computing device (e.g., controller, processor, etc.).

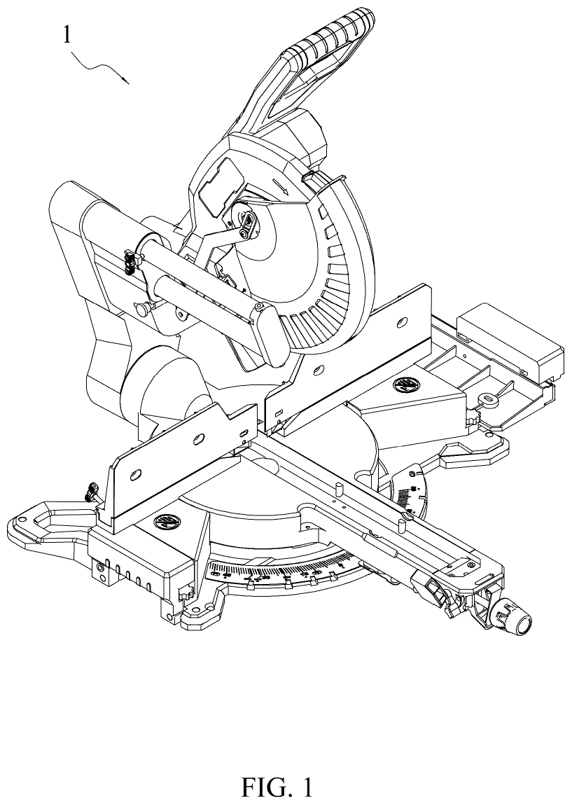

FIG. 1 shows a power tool according to an example of the present application, where the power tool is a miter saw. It is to be understood by those skilled in the art that the power tool provided by the present application is not limited to the miter saw and may be a table saw, an angle grinder, an electric drill, a chain saw, a string trimmer, or the like.

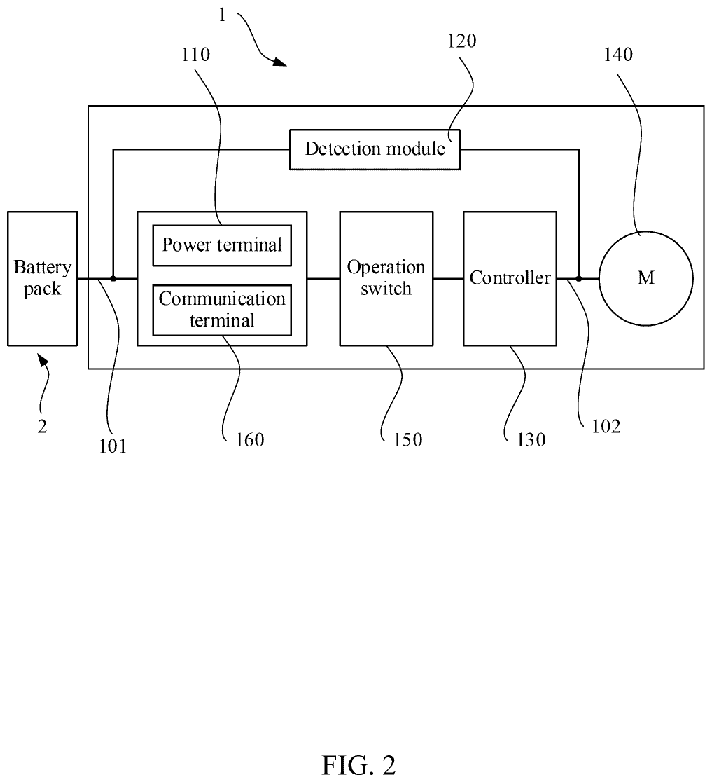

FIG. 2 is a block diagram of a power-off protection circuit of a power tool according to an example of the present application. Referring to FIG. 2, a power tool 1 includes a power terminal 110, a detection module 120, a controller 130, and a motor 140. The motor 140 may be a brushless motor. The power terminal 110 is configured to be electrically connected to a battery pack 2 to access a power supply of the battery pack 2. A circuit between the power terminal 110 and the battery pack 2 is a first circuit 101, and a circuit between the power terminal 110 and the motor 140 is a second circuit 102. The detection module 120 can detect that the first circuit 101 and the second circuit 102 are in a power-on mode or a power-off mode. The controller 130 can control the second circuit 102 to be in the power-on mode or the power-off mode.

When the first circuit 101 is in the power-on mode, the power supply of the battery pack 2 can be supplied to the power tool 1, that is, the battery pack 2 is in good contact with an electrical connection structure of the power tool 1. When the first circuit 101 is in the power-off mode, that is, the battery pack 2 is not electrically connected to the power tool 1, for example, the battery pack 2 is separated from the power tool 1, the power supply of the battery pack 2 cannot be supplied to the power tool 1. In some examples, the battery pack 2 is plugged into the power tool 1, where the first circuit 101 is in the power-on mode when the battery pack 2 is plugged into the power tool 1, and the first circuit 101 is in the power-off mode when the battery pack 2 is pulled out of the power tool 1.

When the second circuit 102 is in the power-on mode, a power supply received by the power terminal 110 from the battery pack 2 can be delivered to the motor 140 so that the motor 140 can rotate. When the second circuit 102 is in the power-off mode, the power supply received by the power terminal 110 from the battery pack 2 cannot be delivered to the motor 140 so that the motor 140 stops rotating or keeps still.

The power tool 1 further includes an operation switch 150 disposed between the power terminal 110 and the motor 140. The operation switch 150 can control the second circuit 102 to be in the power-off mode or control, through the controller 130, the second circuit 102 to be in the power-on mode. In some examples, the operation switch 150 can be moved between a first position and a second position. When the operation switch 150 is at the first position, the operation switch 150 is in the off state, and when the operation switch 150 is at the second position, the operation switch 150 is in the on state. When the operation switch 150 is in the off state, the second circuit 102 is in the power-off mode. When the operation switch 150 is in the on state, the controller 130 can control the second circuit 102 to be in the power-on mode.

In some examples, if the operation switch 150 can directly control whether the second circuit 102 is in the power-on mode, a relatively high security risk is caused. For example, the operation of safely replacing the battery pack 2 should be as follows: the operation switch 150 is turned off so that the second circuit 102 is in the power-off mode, next, the battery pack 2 is pulled out so that the first circuit 101 is in the power-off mode, then another battery pack 2 is plugged so that the first circuit 101 is restored to the power-on mode but the operation switch 150 is kept in the off state so that the second circuit 102 is in the power-off mode, and when a user needs to work by using the power tool 1, the operation switch 150 is turned on so that the second circuit 102 is switched from the power-off mode to the power-on mode. In some scenarios, the user may replace the battery pack 2 in violation of regulations: when the operation switch 150 is in the on state, the battery pack 2 is directly pulled out and then another battery pack 2 is plugged. In the replacement process, the second circuit 102 is always in the power-on mode, and when the first circuit 101 is restored to the power-on mode, the power supply of the battery pack 2 can be quickly delivered to the motor 140 through the first circuit 101 and the second circuit 102 so that the motor 140 in a coast state is driven to rotate again (after the power supply is stopped, the motor 140 does not stop rotating immediately but coasts for a period of time under the action of inertia). Power tools such as the miter saw or the angle grinder have relatively high inertia. Therefore, the motor 140 of this type of power tool 1 coasts for a relatively long time after the power-off. If the operation switch 150 is kept in the on state when the user replaces the battery pack 2 of the miter saw, the motor 140 of the miter saw into which the battery pack 2 is plugged again is started in the coast state, and a saw blade is driven to rotate quickly and may hurt an unprepared person near the miter saw.

To resolve the preceding security risk, the present application provides an example. In this example, when the detection module 120 detects that the first circuit 101 is switched from the power-on mode to the power-off mode, the controller 130 controls the second circuit 102 to be in the power-off mode within a first preset time. Optionally, the first preset time may be greater than or equal to a coast time of the motor 140. Specifically, the first preset time may be 2 seconds, 5 seconds, or 10 seconds.

In this example, after the battery pack 2 is pulled out of the power tool 1, the controller 130 controls the second circuit 102 to be in the power-off mode within the first preset time so that the case is avoided where the motor 140 is powered on again immediately after the power-off so as to drive a working accessory to rotate quickly. Thus, the security risk of the power tool 1 is reduced.

In this example, even if the detection module 120 detects, within the first preset time, that the first circuit 101 is switched from the power-off mode to the power-on mode, the controller 130 still controls the second circuit 102 to be in the power-off mode within the first preset time. The controller 130 controls the second circuit 102 to be in the power-on mode only when the detection module 120 detects, outside the first preset time, that the first circuit 101 is in the power-on mode.

In some examples, the operation switch 150 is configured to be incapable of directly controlling the second circuit 102 to be switched from the power-off mode to the power-on mode, and the operation switch 150 needs to control, through the controller 130, the second circuit 102 to be switched to the power-on mode. For example, after the battery pack 2 is pulled out of the power tool 1, the controller 130 controls the second circuit 102 to be in the power-off mode within the first preset time. Even if the operation switch 150 is always in the on state within the first preset time or is switched from the off state to the on state, the controller 130 still controls the second circuit 102 to be in the power-off mode within the first preset time. The controller 130 controls the second circuit 102 to be in the power-on mode only when the detection module 120 detects, outside the first preset time, that the first circuit 101 is in the power-on mode and the operation switch 150 is in the on state outside the first preset time.

The power tool 1 further includes a communication terminal 160, and the communication terminal 160 performs data communication with the battery pack 2. When the battery pack 2 is pulled out of the power tool 1, the first circuit 101 is switched from the power-on mode to the power-off mode, no data communication occurs between the communication terminal 160 and the battery pack 2, and a level of the communication terminal 160 keeps stable. Therefore, the detection module 130 can assist in determining, by detecting whether the level of the communication terminal 160 varies, whether the battery pack 2 is not electrically connected to the power tool 1, that is, the detection module 130 can determine, based on whether the level of the communication terminal 160 varies, that the first circuit 101 is in the power-on mode or the power-off mode.

After the battery pack 2 is pulled out of the power tool 1, the first circuit 101 is switched from the power-on mode to the power-off mode. However, the motor 140 does not immediately stop rotating. Instead, the motor 140 coasts for a period of time under the action of the inertia. The motor 140 generates a back electromotive force in the coast state. Therefore, a small current is generated. Therefore, the detection module 130 can assist in determining, by detecting the magnitude of the phase current of the motor, whether the battery pack 2 is not electrically connected to the power tool 1, that is, the detection module 130 can determine, based on the magnitude of the phase current of the motor 140, that the first circuit 101 is in the power-on mode or the power-off mode.

In summary, the present application provides an example in which it can be determined, in a relatively accurate manner, whether the first circuit 101 is switched from the power-on mode to the power-off mode. In this example, the detection module 120 can detect whether the level of the communication terminal 160 varies, and the detection module 120 can further detect the phase current of the motor 140. When the absolute value of the phase current of the motor 140 is less than a preset current threshold and the level of the communication terminal 160 does not vary within a second preset time, the detection module 120 determines that the first circuit 101 is in the power-off mode.

The present application further provides an example in which it can be determined whether the first circuit 101 is switched from the power-on mode to the power-off mode. The detection module 120 can detect the back electromotive force of the motor 140 and the bus voltage of the motor 140. When the difference between the back electromotive force of the motor 140 and the bus voltage of the motor 140 is less than a preset voltage threshold within a third preset time, the detection module 120 determines that the first circuit 101 is in the power-off mode. In some examples, the product of a current of the unloaded motor 140 and an internal resistance of the motor 140 may be calculated and used as a basis for a value range of the preset voltage threshold.

To resolve the security risk mentioned above, the present application further provides another example. In this example, when the detection module 120 detects that the first circuit 101 is switched from the power-off mode to the power-on mode, the controller 30 controls the second circuit 102 based on a time when the first circuit 101 is in the power-off mode before the mode switchover. If the time when the first circuit 101 is in the power-off mode before the mode switchover does not exceed the first preset time, the second circuit 102 is controlled to be in the power-off mode. Optionally, the first preset time may be greater than or equal to 2 seconds and less than or equal to 10 seconds.

In some examples, if the time when the first circuit 101 is in the power-off mode before the mode switchover has exceeded the first preset time, the controller 30 may control the second circuit 102 to be in the power-on mode.

In some examples, the operation switch 150 is configured to be incapable of directly controlling the second circuit 102 to be switched from the power-off mode to the power-on mode, and the operation switch 150 needs to control, through the controller 130, the second circuit 102 to be switched to the power-on mode. When the detection module 120 detects that the first circuit 101 is switched from the power-off mode to the power-on mode, the controller 30 controls the second circuit 102 to be in the power-off mode if the operation switch 150 is in the on mode and the time when the first circuit 101 is in the power-off mode before the mode switchover does not exceed the first preset time.

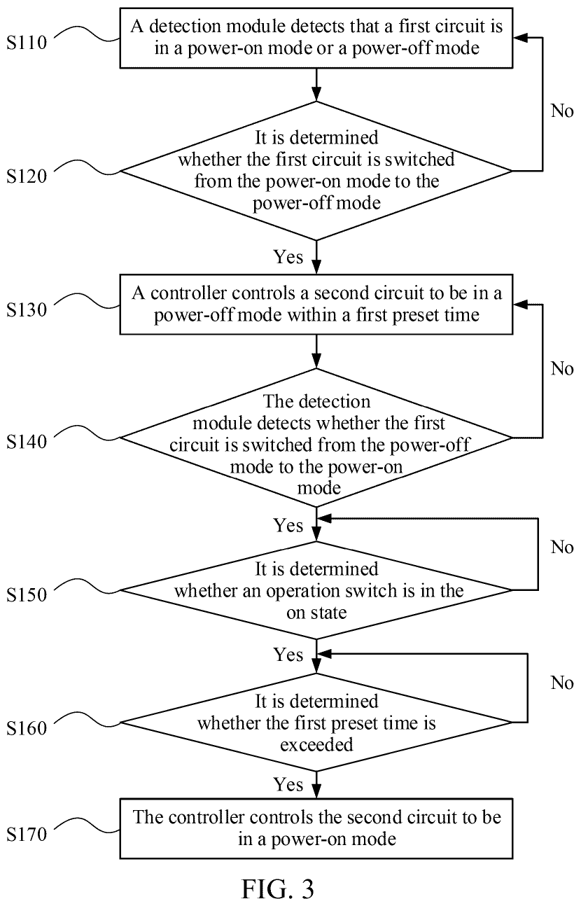

As shown in FIG. 3, the present application further provides a power-off protection method applicable to the power tool 1 such as the miter saw. The power tool 1 includes the motor 140, the power terminal 110, the detection module 120, the controller 130, and the operation switch 150 as mentioned in the preceding example. The power-off protection method includes the steps below.

In S110, the detection module 120 detects that the first circuit 101 is in the power-on mode or the power-off mode.

In S120, it is determined whether the first circuit 101 is switched from the power-on mode to the power-off mode. If yes, step S130 is performed. If not, the detection is continued.

In S130, the controller 140 controls the second circuit 102 to be in the power-off mode within the first preset time.

In S140, the detection module 120 detects whether the first circuit 101 is switched from the power-off mode to the power-on mode. If yes, step S150 is performed. If not, step S130 is performed.

In S150, it is determined whether the operation switch is in the on state. If yes, step S160 is performed. If not, it is continuously detected whether the operation switch is in the on state.

In S160, it is determined whether the first preset time is exceeded. If yes, step S170 is performed. If not, it is continuously detected whether the first preset time is exceeded.

In S170, the controller 140 controls the second circuit 102 to be in the power-on mode.

The preceding power-off protection method improves the security performance of the power tool 1.

The basic principles, main features, and advantages of this application are shown and described above. It is to be understood by those skilled in the art that the aforementioned examples do not limit the present application in any form, and all technical solutions obtained through equivalent substitutions or equivalent transformations fall within the scope of the present application.

What is claimed is:

1. A power tool, comprising:
a motor;
a power terminal configured to access a power supply of a battery pack;
a detection module capable of detecting that a first circuit between the power terminal and the battery pack is in a power-on mode or a power-off mode; and
a controller capable of controlling a second circuit between the power terminal and the motor to be in a power-on mode or a power-off mode;
wherein the controller is configured to, when the detection module detects that the first circuit is switched from the power-on mode to the power-off mode, control the second circuit to be in the power-off mode within a first preset time.

2. The power tool according to claim 1, wherein the controller is configured to, when the detection module detects, within the first preset time, that the first circuit is in the power-on mode again, control the second circuit to be in the power-off mode within the first preset time.

3. The power tool according to claim 2, wherein the controller is configured to, when the detection module detects, outside the first preset time, that the first circuit is in the power-on mode, control the second circuit to be in the power-on mode.

4. The power tool according to claim 1, further comprising an operation switch capable of controlling the second circuit to be in the power-on mode or the power-off mode, wherein the controller controls the second circuit to be in the power-off mode when the operation switch is in an off state.

5. The power tool according to claim 1, further comprising an operation switch capable of controlling the second circuit to be in the power-on mode or the power-off mode, wherein the second circuit is in the power-off mode when the operation switch is in an off state, and the controller controls the second circuit to be in the power-on mode or the power-off mode when the operation switch is in an on state.

6. The power tool according to claim 4, wherein the controller is configured to, when the operation switch is in the on state within the first preset time and the detection module detects, within the first preset time, that the first circuit is in the power-on mode again, control the second circuit to be in the power-off mode within the first preset time.

7. The power tool according to claim 6, wherein the controller is configured to, when the operation switch is in the on state outside the first preset time and the detection module detects, outside the first preset time, that the first circuit is in the power-on mode, control the second circuit to be in the power-on mode.

8. The power tool according to claim 4, wherein the controller is configured to, when the operation switch is switched from the off state to the on state within the first preset time and the detection module detects, within the first preset time, that the first circuit is in the power-on mode again, control the second circuit to be in the power-off mode within the first preset time.

9. The power tool according to claim 1, further comprising a communication terminal configured to perform data communication with the battery pack, wherein the detection module is capable of detecting whether a level of the communication terminal varies.

10. The power tool according to claim 9, wherein the detection module determines, based on whether the level of the communication terminal varies, that the first circuit is in the power-on mode or the power-off mode.

11. The power tool according to claim 10, wherein the detection module is also capable of detecting a phase current of the motor and determining, based on a magnitude of the phase current of the motor, that the first circuit is in the power-on mode or the power-off mode.

12. The power tool according to claim 9, wherein the detection module is also capable of detecting a phase current of the motor and is configured to, when an absolute value of the phase current of the motor is less than a preset current threshold and the level of the communication terminal does not vary within a second preset time, determine that the first circuit is in the power-off mode.

13. The power tool according to claim 1, wherein the detection module is also capable of detecting a back electromotive force of the motor and a bus voltage of the motor and is configured to, when a difference between the back electromotive force of the motor and the bus voltage of the motor is less than a preset voltage threshold within a third preset time, determine that the first circuit is in the power-off mode.

14. The power tool according to claim 1, wherein the battery pack is plugged to the power tool, the first circuit is in the power-on mode when the battery pack is plugged to the power tool, and the first circuit is in the power-off mode when the battery pack is pulled out of the power tool.

15. The power tool according to claim 1, wherein the first preset time is greater than or equal to a coast time of the motor.

16. A power tool, comprising:
a motor;
a power terminal configured to access a power supply of a battery pack;
a detection module capable of detecting that a first circuit between the power terminal and the battery pack is in a power-on mode or a power-off mode; and
a controller capable of controlling a second circuit between the power terminal and the motor to be in a power-on mode or a power-off mode;
wherein the controller is configured to, when the detection module detects that the first circuit is switched from the power-off mode to the power-on mode, control the second circuit to be in the power-off mode if a time when the first circuit is in the power-off mode before the switchover does not exceed a first preset time.

17. The power tool according to claim 16, wherein the first preset time is greater than or equal to 2 seconds and less than or equal to 10 seconds.

18. The power tool according to claim 16, wherein the controller is configured to, when the detection module detects that the first circuit is switched from the power-off mode to the power-on mode, control the second circuit to be in the power-on mode if a time when the first circuit is in the power-off mode before the switchover exceeds the first preset time.

19. The power tool according to claim 16, further comprising an operation switch, wherein the controller is configured to, when the detection module detects that the first circuit is switched from the power-off mode to the power-on mode, control the second circuit to be in the power-off mode if the operation switch is in an on state and a time when the first circuit is in the power-off mode before the switchover does not exceed the first preset time.

20. A power-off protection method of a power tool comprised of a motor, a power terminal configured to access a power supply of a battery pack, a detection module capable of detecting that a first circuit between the power terminal and the battery pack is in a power-on mode or a power-off mode, and a controller capable of controlling a second circuit between the power terminal and the motor to be in a power-on mode or a power-off mode, the method comprising:
when the detection module detects that the first circuit is switched from the power-on mode to the power-off mode, controlling by the controller the second circuit to be in the power-off mode within a first preset time.
